(19) United States
(12) Patent Application Publication
(10) Pub. No.: US 2026/0094114 A1
(43) Pub. Date: Apr. 2, 2026

(54) CARBON EMISSION CALCULATION DEVICE, CALCULATION SYSTEM AND CALCULATION METHOD

(71) Applicant: Mitsubishi Electric Corporation, Tokyo (JP)

(72) Inventor: Keita KUBO, Vernon Hills, IL (US)

(73) Assignee: Mitsubishi Electric Corporation, Tokyo (JP)

(21) Appl. No.: 18/902,570

(22) Filed: Sep. 30, 2024

(51) Int. Cl. G06Q 10/087; G06F 3/04817; G06F 3/04842; G06F 3/04845; G06Q 30/0601

(52) U.S. Cl. CPC G06Q 10/087; G06F 3/04817; G06F 3/04842; G06F 3/04845; G06Q 30/0643

(57) ABSTRACT

A product carbon footprint (PCF) calculation device, including data storage for storing order information, resource data, products parts configuration and production plans, a display, and circuitry for receiving a user input, the user input including a product to be manufactured and parameters for the product to be manufactured, extracting the resource data from the data storage, performing PCF calculation based on the extracted resource data and the order information, displaying the PCF calculation on the display, and causing the execution of the product.

Carbon emission calculation for selecting products for manufacture based on price, production capacity, product carbon footprint (PCF), and other criteria.

### SUMMARY

According to an aspect, a product carbon footprint (PCF) calculation device includes data storage to store order information, resource data, products parts configuration and production plans, a display and circuitry configured to receive a user input, the user input including a product to be manufactured and parameters for the product to be manufactured, extract the resource data from the data storage, perform PCF calculation based on the extracted resource data and the order information, display the PCF calculation on the display and cause the execution of the product.

According to another aspect, a method of performing product carbon footprint (PCF) calculation includes obtaining order information for a product from a first input of a user, displaying, on a display, the order information and parameters for the order information, inputting, by the user, percentages for the parameters, extracting resource data from data storage, the resource data including a time to manufacture the product and power to be consumed in the manufacture of the product, calculating the PCF based on the percentages for the parameters and the resource data; and causing an order to be created and the product to be produced.

Yet another aspect includes a non-transitory computer-readable storage medium having stored therein computer-readable instructions as part of a processing program to be used in a processing apparatus, the processing program when executed by computer causing the computer to implement a method of performing product carbon footprint (PCF) calculation, including obtaining order information for a product from a first input of a user, displaying, on a display, the order information and parameters for the order information, inputting, by the user, percentages for the parameters, extracting resource data from data storage, the resource data including a time to manufacture the product and power to be consumed in the manufacture of the product, calculating the PCF based on the percentages for the parameters and the resource data and causing an order to be created and the product to be produced.

### BRIEF DESCRIPTION OF THE DRAWINGS

Embodiments of the present disclosure will become more fully understood from the detailed description given hereinbelow and the accompanying drawings which are given by way of illustration only, and thus are not limitative of one or more embodiments of the present disclosure.

FIG. 1 illustrates a block diagram of the functional configuration of a PCF calculation device according to one or more embodiments of the present disclosure.

FIG. 2 illustrates an example of the data storage structure of the order information storage section according to one or more embodiments of the present disclosure.

FIG. 3 illustrates an example of the data storage structure of the resource data storage section according to one or more embodiments of the present disclosure.

FIG. 4 illustrates an example of the data storage structure of the production plan storage section according to one or more embodiments of the present disclosure.

FIG. 5 illustrates an example of the data storage structure of the product parts configuration storage section according to one or more embodiments of the present disclosure.

FIG. 6 illustrates the hardware configuration when the functions of the PCF calculation device are realized by a computer according to one or more embodiments of the present disclosure.

FIG. 7 illustrates a flowchart of a process the PCF calculator according to one or more embodiments of the present disclosure.

FIG. 8 describes step S4 of the flowchart in FIG. 7 in detail according to one or more embodiments of the present disclosure.

FIG. 9 illustrates a display screen having a user interface according to one or more embodiments of the present disclosure.

FIG. 10 illustrates a display screen showing a simulation result according to one or more embodiments of the present disclosure.

FIG. 11 illustrates a display screen having a user interface according to one or more embodiments of the present disclosure.

FIG. 12 illustrates a display screen having a user interface according to one or more embodiments of the present disclosure.

FIG. 13 illustrates a display screen showing a simulation results according to one or more embodiments of the present disclosure.

FIG. 14 illustrates a display screen having a user interface according to an one or more embodiments of the present disclosure.

### DETAILED DESCRIPTION

Embodiments of the present disclosure can be regarded as being directed to carbon emission calculation for selecting products for manufacture based on price, production capacity, product carbon footprint (PCF), and/or other criteria.

In recent years, the reduction of greenhouse gas emissions has received more attention than ever before, and various industries are required to reduce their emissions. Manufacturers are required to calculate and visualize their product carbon footprint (PCF), including the amount of direct and indirect greenhouse gas emissions throughout the product lifecycle. Some manufacturers are already disclosing PCFs to their supply chains and specifying PCFs at the time of procurement.

However, to lower PCF, costs are likely to increase due to changes in processes and procured materials. For example, the cost and Greenhouse gas (GHG) emissions of electricity used in the manufacturing process will differ between electricity generated by thermal power and electricity generated by wind power, for example. Thermal power generation is generally regarded as less expensive than wind power, but has increased greenhouse gas emissions as compared to wind power. In other words, there is a trade-off between cost and GHG emissions.

In addition, in the optimization of manufacturing processes, it is possible to reduce GHG emissions by work-in-process (WIP) inventory or buffering (i.e., temporarily holding work-in-process in the middle of the production process) to shorten the time of processes involving heat sources (i.e., heat generation), but the delivery time may be delayed. From this point of view, there is a trade-off between delivery time and GHG emissions. In other words, GHG emissions is compared to cost (C) and delivery time (D), which have been in a trade-off relationship up to now, and the trade-off relationship has become more complex. Considering this complex trade-off relationship, the person in charge of manufacturing must execute product production to maximize profit.

In a complex trade-off relationship for various parameters of a product to be manufactured, where the carbon footprint is added to quality, cost, and delivery time (e.g., parameters), each parameter is set up using a user interface of a product carbon footprint (PCF) calculation device. The ratio of each of the parameters is selected, and the sum of ratios of the parameters equals 100%. The PCF calculation device accumulates data on each resource required for product manufacturing, including but not limited to materials (i.e., materials used), processes (i.e., processes included in the product manufacturing), power (i.e., power consumption), price, production capacity, and PCF, based on the percentage of each parameter in the trade-off relationship entered through the user interface. An accuracy of a simulation of a product to be produced, as described below, is improved through PCF calculation.

A product's carbon footprint is a way to measure the amount of greenhouse gas emissions that a product produces throughout its life cycle. This includes emissions from the extraction of raw materials, manufacturing of the product, transportation of the product, usage of the product, and disposal of the product. The PCF can be expressed as an annualized basis, or a per use or dosage basis. For example, a vehicle's PCF could be expressed per year of ownership or per kilometer (i.e., mile) traveled. Further, the PCF can help identify areas where a product's climate impact is significant to reduce emissions and support eco-conscious decision-making. Manufacturers first create a lifecycle assessment (LCA) to form the basis for a PCF report. The process for calculating a PCF includes defining the product, objectives, system boundaries, and audience, collecting relevant inputs and outputs, analyzing activity data, using emission factors to calculate the PCF, evaluating and interpreting the results, and validating and reporting the results. Some companies display a PCF label on their products to help consumers understand their environmental impact.

According to one or more embodiments of the present disclosure, it can be possible to extract the necessary resource data and calculate the PCF, cost (total cost, including total energy cost, total material cost, labor and every other known factor), and production time based on the ratio of each parameter in the trade-off relationship entered using the user interface. The user interface can include a polygon (e.g., a triangle, quadrilateral, pentagon, hexagon, heptagon, etc.) with each parameter in the tradeoff relationship located at a vertex of the polygon, and by moving a movable icon (e.g., dot or selector) within the polygon, the user can intuitively set the ratio for each parameter. For example, in the case of a tradeoff between cost, delivery time, and carbon footprint, the polygon is a triangle, and each of cost, delivery time and carbon footprint are located at a distinct vertex.

The above-described features of the present disclosure can allow the user to easily adjust the PCF prior to product manufacture without having to extract all the elements necessary for PCF calculation.

Embodiments of the present disclosure will now be described with reference to the accompanying drawings, wherein the same reference numerals have been used to identify the same or similar elements throughout the several views.

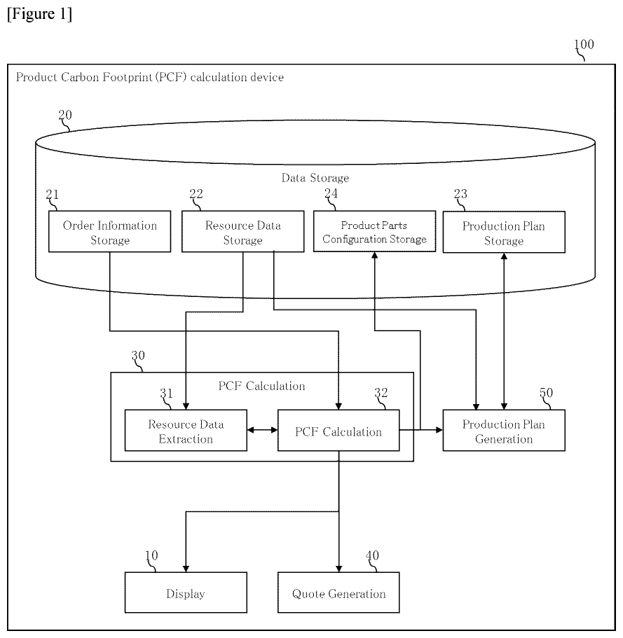

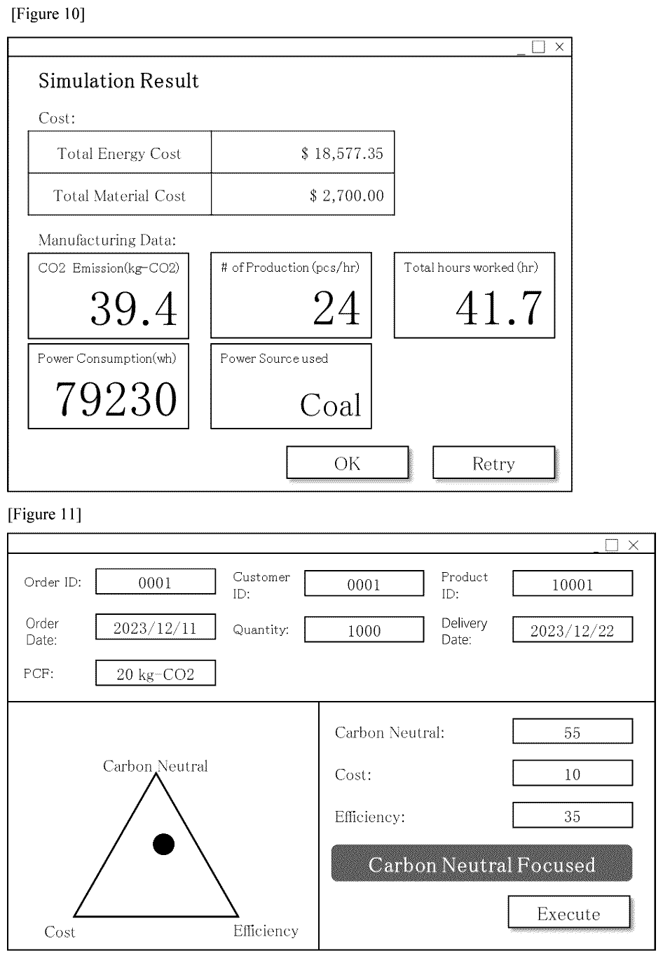

FIG. 1 illustrates a block diagram of a functional configuration of the PCF calculation device 100 according to one or more embodiments of the present disclosure. PCF calculation device 100 can include a data storage section 20 (e.g., memory, storage, etc.) that can store product order information and resource data necessary for manufacturing, a PCF calculation section 30 that calculates the PCF using order information, resource data, and trade-off values of parameters, a quotation generation section 40 that can generate a quote (e.g., a cost breakdown, including total energy cost, total material cost, total labor cost, transportation, etc.) for a product from the PCF calculation results, and a production plan generation section 50 that can output a production plan based on the PCF calculation results. The quotation generation section 40 can also include each of the elements shown in FIGS. 10 and 13, including manufacturing data, such as CO₂ emissions, production (e.g., number of components/pieces that are capable of being manufactured per hour), total hours need to complete the order, total power consumption (in watt-hours (Wh)) to complete the order, and the type of power source used, such as coal, wind, solar, nuclear, etc.

The PCF calculation unit 30, the quotation generation unit 40 that generates a quote for a product from the PCF calculation results, and the production plan generation unit 50 that outputs a production plan based on the PCF calculation results. Each of the PCF calculation unit 30, the quotation generation unit 40, and the production plan generation unit 50 can be implemented by a hardware-embedded computer (e.g., CPU, circuitry, processor, and the like). A display unit 10, such as a monitor or display, is provided as an output device between the user and the device. The display unit 10 may be a light-emitting diode display, an LCD display, an OLED display, a plasma display, an IPS display and the like.

According to one or more embodiments of the present disclosure, the PCF calculation device 10 can include an input device and/or data processing device, and the input device and/or data processing device can include at least one of a keyboard, a hardware button, a pointing device, a mouse, a remote control, a touch sensor, an illuminance sensor, an imaging device, an audio input device, an eye-gaze input device, and an demeanor sensing device, and a display panel. The input device and/or data processing device can utilize wireless technology to communicate a user input/transmit a signal, such as Bluetooth, Ultra-Wideband (UWB), ZigBee, Radio Frequency (RF), and IR). Specifically, a keyboard, a hardware button, a pointing device, a touch sensor, an audio input device, an eye-gaze input device, or the like can be used as a user input.

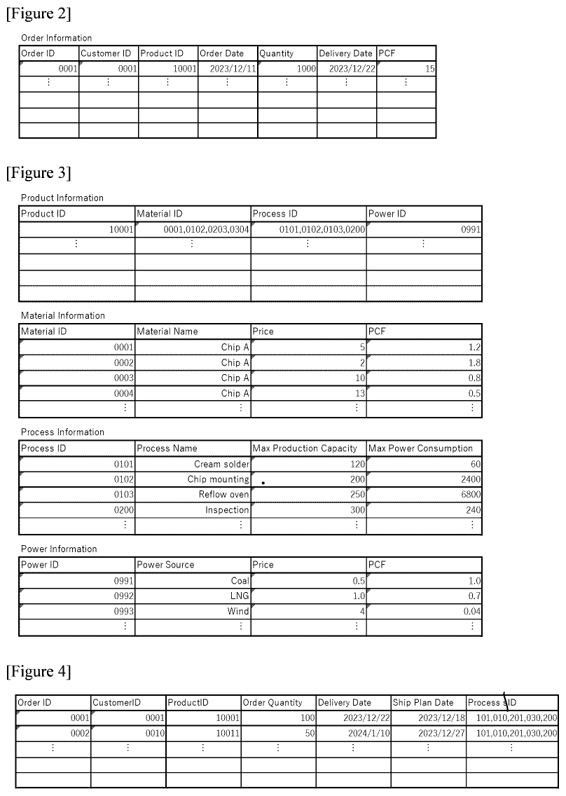

FIG. 2 illustrates an example of the data storage structure of the order information storage section 21 (which can be referred to as “order information storage”) according to one or more embodiments of the present disclosure. The order information can include, for example, columns for the following: order ID to identify the order, customer ID to identify the customer, product ID to identify the product, order date, order quantity, delivery date (e.g., desired delivery date or expected delivery date), PCF value, etc. The PCF value can be the PCF value specified at the time the order is received, for example, if “PCF value less than 20 kg-CO2” is specified, that value is entered. Order information can be entered at the time the order is received.

FIG. 3 illustrates an example of the data storage structure of the resource data storage section 22 according to one or more embodiments of the present disclosure. The data storage structure can be in the form of a table. FIG. 3 illustrates four separate categories, including “Product Information,” “Material Information,” “Process Information,” and “Power Information,” however, the embodiments of the present disclosure are not limited to these categories, and any other type of known category for a product can be utilized.

“Product Information” can include “Product ID,” “Material ID,” “Process ID,” and “Power ID.” Product ID can include identification information, such as an identification number, for the product (i.e., unique to the product). Material ID can include the material used for the product, Process ID can include the process(es) required to manufacture the product, and Power ID can include the power consumption and/or power type used to manufacture the product. “Material Information” includes “Material ID,” “Material Name,” “Price,” and PCF, each of which are clearly defined above. For instance, the Price can be any format (e.g., currency), and can be changed to the format based on user preference and selection. For example, the price can be in U.S. dollars, or in Japanese Yen. “Process Information” can include “Process ID,” “Process Name,” “Max Production Capacity,” and “Max Power Consumption.” Max Production Capacity can be in the form of units of product produced per day. Max Power Consumption can be any format, including KW-h, and can be the total power consumption of a particular material/element used to manufacture the product. FIG. 3 illustrates, for instance, various processes (Process ID's 0101, 0102, 0103, 0200) used to manufacture “Chip A,” and the maximum production capacity and the maximum production capacity for each process used to manufactured “Chip A.” “Power Information” can include “Power ID,” “Power Source,” “Price,” and “PCF.” Power source can be the power source used to manufacture the product.

Resource data can be a collection of data necessary for manufacturing products, such as data identifying products, materials, processes, and power consumption. For example, product ID 10001 of product information can have material IDs 0001, 0102, 0203, 0304 of the materials used, Process IDs 0101, 0102, 0103, 0200 of the processes required for manufacturing, and a Power ID 0991 of the power source used in the manufacture of the product. For example, the Material ID 0001 in the “Material Information” section of the table, has the part name “Chip A,” the price 5, and the PCF 1.2. In this part information, there can be a trade-off between price and PCF. If the same “Chip A” is to be used at a lower price, the part ID is 0002, but the PCF is increased to 1.8. Also, if Process ID 0101 is checked in the process information, it has the process name “cream solder application,” the maximum production capacity of 120, and the maximum power consumption of 60. The production capacity is related to efficiency, and the power consumption is used to calculate the PCF emitted by the process. In this process information, there can be a trade-off between production capacity and power consumption, and increasing production capacity also increases power consumption, resulting in an increase in PCF. Furthermore, when Power ID 0991 is checked in the power information, it has information on the power source “coal-fired”, price 0.5, and PCF 1.0. As with the material information, there can be a trade-off between price and PCF, and selecting wind power with a lower PCF will increase the price to 4.

FIG. 4 illustrates an example of the data storage structure of the production plan storage section 23 according to one or more embodiments of the present disclosure. The data storage structure of the production plan storage section 23 can be in the form of a table, as shown in FIG. 4. FIG. 4 includes separate columns for “Order ID,” “Customer ID,” “Product ID,” “Order Quantity,” “Delivery Date,” “Ship Plan Date,” and “Process ID.” The production plan is a summary of plans related to product manufacturing. The production plan can include the type, quantity, and timing of products to be produced, raw materials and components, processes, and the number of days from manufacturing to shipping. For example, Order ID 0001 is an order for 100 units of the product with Product ID 10001 from the customer with Customer ID 0001, as described in the “Order Quantity” column, the “Delivery Date” is 2023 Dec. 22 the “Ship Plan Date” is 2023 Dec. 18 and the Process IDs are 101, 010, 201, 030 and 200.

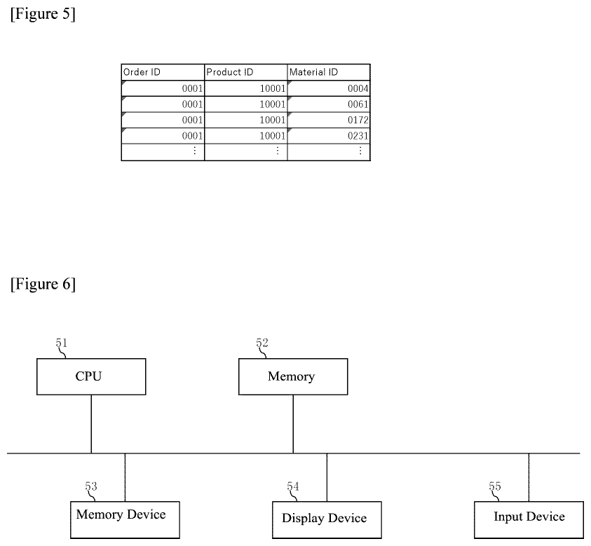

FIG. 5 illustrates an example of the data storage structure of the product parts configuration storage section 24 according to one or more embodiments of the present disclosure, which can be in the form of a table, but is not limited thereto. The product parts configuration storage section 24 can register the parts configuration of the product to be manufactured. For example, order ID 0001 can use parts with Material ID 0004, 0061, 0172 and 0231 in the manufacture of Product ID 10001.

FIG. 6 illustrates a hardware configuration when the functions of the PCF calculation device 100 are realized by a computer according to one or more embodiments of the present disclosure. The functions of PCF calculation section 30 and quotation generation section 40 can be realized by hardware or software, which is written as programs and stored in memory device 53. The CPU 51 can read the PCF calculation program stored in memory 52 and execute it to realize the functions of each part of the PCF calculation part 30 and the quotation generation part 40. The memory device 53 can also function as the data storage section 20. Memory 52 corresponds to a volatile storage area such as RAM (Random Access Memory). Memory device 53 corresponds to the nonvolatile storage area called ROM (Read Only Memory), flash memory EPROM (Erasable Programmable Read Only Memory), EEPROM (Electrically Erasable Programmable Read Only Memory), and EEPROM (Electrically Erasable Programmable Read Only Memory). Memory), magnetic disks, flexible disks, flash memory, etc., are applicable. The display device 54 can function as the display section 10. The display device 54 can be any type of display device, including a light-emitting diode (LED) display, an OLED display, a liquid crystal display (LCD), plasma panel display (PDP) and the like. Element 55 is an input device, which may be a mouse, keyboard, and the like.

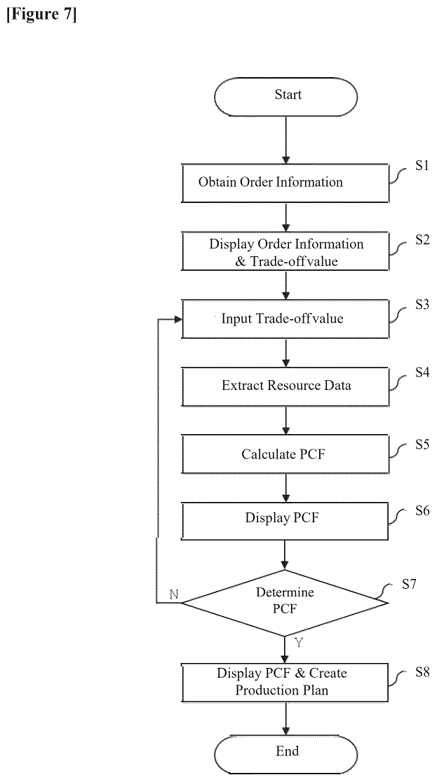

FIG. 7 illustrates a flowchart of a process of the PCF calculator 100 according to one or more embodiments of the present disclosure, which can include steps S1-S8. The PCF calculator 100 can be started and order information can be obtained in step S1. This order information can be stored in the order information storage section 21. In step S2, the order information obtained in step S1 can be displayed on the display device 54. The carbon neutrality (i.e., “Carbon Neutral”), cost, efficiency, and their ratios, which can be in a trade-off relationship, can also be provided on a user interface displayed on the display device 54 in step S2. Carbon neutrality, for purposes of this specification, can be defined as how much greenhouse gas emissions can be reduced when manufacturing a product, “cost” can be the manufacturing cost of a product, and “efficiency” can be how much product can be manufactured per hour. A higher value for carbon neutrality can equate to less greenhouse gas emissions in manufacturing, a higher value for cost can equate to less manufacturing cost, and a higher value for efficiency can equate to more products are manufactured per hour.

In step S3, a user can enter the percentage for at least one of the parameters, and preferably, at least two parameters, in an input section of a user interface displayed in step S2, or alternatively, the user adjusts an input interface displayed (see, e.g., FIGS. 9, 11, 12, and 14). The input interface can include the parameters to be adjusted (e.g., carbon neutrality, cost, efficiency, etc.) at vertices of a polygon (see, e.g., FIG. 9, for instance, which illustrates a triangle), and the balance of the parameters can be represented, in FIGS. 9, 11, 12 and 14, by a movable icon (e.g., dot, selector, circle, etc.). The movable icon can have any shape. By moving the movable icon within the polygon, the parameters can be automatically adjusted, and the ratio among the parameters can be referred to as the trade-off ratio. For instance, if a user moves the movable icon (via the input device 55) towards the carbon neutrality parameter, carbon neutrality will represent a higher priority for searching a product and process stored in the data storage 20. The percentage can be entered so that the total of each parameter is 100. If the percentages does not total 100, the device can automatically adjust the percentages to total 100 and can perform a search based on the adjusted parameters. Of the numerical values entered, the parameter with the highest value can have the highest priority and can determine what will be prioritized for selection and production. Furthermore, the numerical values entered here can be used to extract resource data and calculate the PCF.

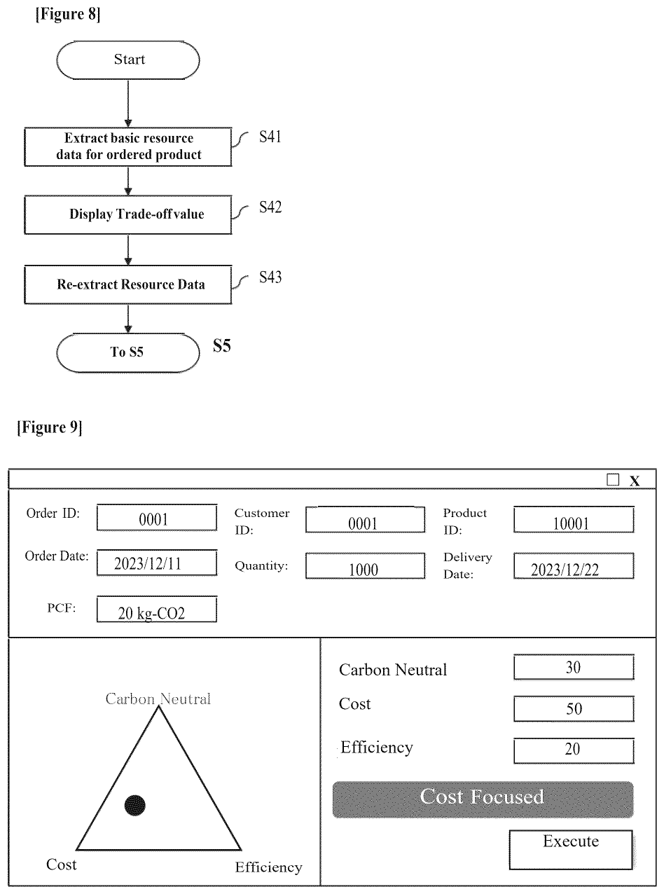

In step S4, resource data can be extracted. This can be done by selecting the optimal resource from the resource data storage section 22 based on the trade-off ratio. The resource selection method is described below and an example of which is shown in FIG. 8, which is separated into steps S41-S43.

In step S5, the PCF can be calculated by considering (i.e., based on) the ratio of trade-offs entered to the PCFs possessed by the extracted resource data. For resources that do not have a PCF retrieved directly from the resource data, the PCF can be calculated by calculating the time required for manufacturing from the recorded production capacity, the power consumed and the power generation type. The final product PCF can be calculated by a materials and manufacturing data source, which can include a PCF for each material used to manufacture the product.

In step S6, the PCF results calculated in step S5 can be displayed on the display device 54. In step S7, the PCF displayed in step S6 can be viewed to determine whether manufacturing can be executed or not (see the “Execute” icon in FIGS. 9, 11, 12 and 14, which can cause an order to be created and the product to be manufactured). If manufacturing execution is not possible, for example, if the order conditions are not met (i.e., “N” in step S7), the trade-off value input in step S3 can be performed again, for instance, by a user (see the arrow from S7 to S3 in FIG. 7). The PCF calculator 100 can execute the procedure according to the flowchart of FIG. 7.

In step S8, the PCF can be displayed on the display device 54, and then the product/component can be manufactured. Specifically, in step S8, a production plan can be generated based on the calculated PCF value and extracted resource data. In the production plan, for example, the type, quantity, timing, materials, process, and/or number of days from manufacturing to shipping of the products to be produced can be subject to planning.

FIG. 8 illustrates a flowchart of step S4 (illustrated in FIG. 7) in detail, which can include steps S41-S43. In step S41, the basic resource data for the product (e.g., ordered product or product that may be ordered once the execution icon is selected) is extracted. In step S42, the trade-off values entered in step S3 can be reflected in the basic resource data. In step S43, the appropriate resource data can be extracted again (i.e., re-extracted) based on the result of reflecting the trade-off values in the basic resource data.

FIGS. 9 through 14 illustrate the implementations based on the flowcharts in FIGS. 7 and 8 according to one or more embodiments of the present disclosure. FIG. 9 illustrates a Cost Focus scenario, in which cost has the greatest priority among the parameters. FIGS. 11, 12, and 14 illustrate Carbon Neutral Focus scenarios, in which carbon neutrality has the greatest priority among the parameters. The process steps of FIGS. 7 and 8 are described further below with respect to FIGS. 9, 11, 12, and 14.

FIGS. 9, 11, 12, and 14 all include product/customer information on a top section of the user interface, according to one or more embodiments of the present disclosure. The top section of the user interface can be designated a first portion. Further, a lower-left portion of the user interface can include a polygon or other shaped object having a plurality of vertices. FIGS. 9, 11, 12, and 14 illustrate a triangle having three vertices, as an example. Each vertex can represent a parameter (e.g., user modifiable parameter, as noted above) and the polygon can further include a movable icon therewithin (i.e., displayed inside all of the vertices or inside of the polygon/shape), which can be movable by a user input (via the input device 55) to modify the priority of the parameters. The lower-left portion of the user interface can be designated as a second portion.

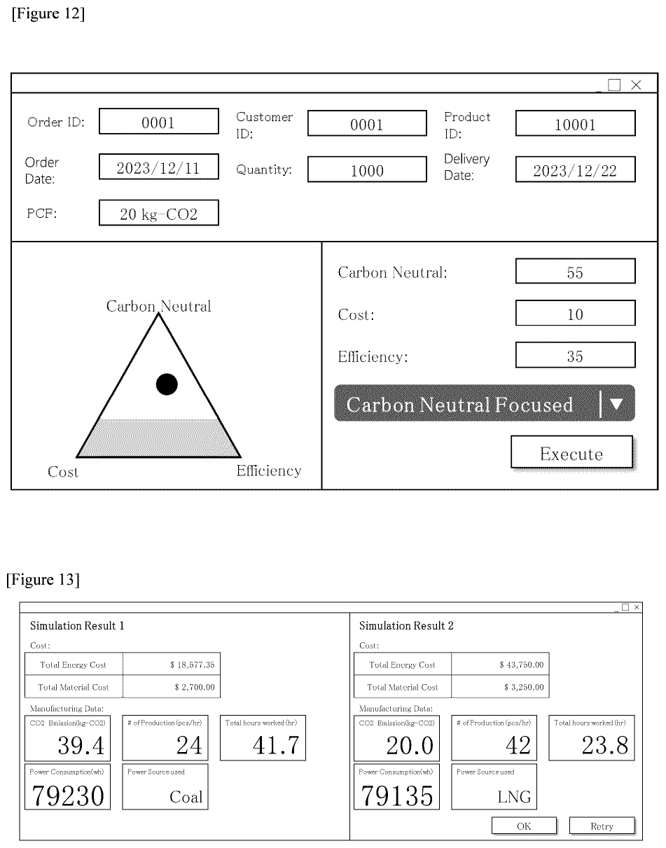

Modifying the priority of the parameters via user input to the movable icon can automatically change values associated with the parameters in a lower-right portion of the user interface. The lower-right portion of the user interface can include at least the parameters adjacent to (e.g., next to) a numerical input acceptance field indicating a numerical value out of 100, which can represent a percentage, a tradeoff emphasis setting parameter (e.g., “Cost/Efficiency/Carbon Neutral Focused” indication or prompt), and an execute icon. The lower-right portion of the user interface can be designated as a third portion or the input section. The tradeoff emphasis setting parameter can include an arrow (see, e.g., FIG. 12) to allow the user to select a focus on any one of the parameters. Once the user selects one of the parameters in the tradeoff emphasis setting parameter, all of the parameters can be automatically adjusted, with the selected one of the parameters having the greatest percentage/priority.

In step S1, order information can be acquired. The order information acquired can include the Order ID (i.e., 0001), the Customer ID (i.e., 0001), the Product ID (i.e., 10001), the Order date 2023 Dec. 11, Quantity (i.e., order quantity) 1000 pieces, Delivery Date 2023 Dec. 22, and PCF 20 kg-CO2, and this information can be stored in the order information storage section 21.

In step S2, the order information obtained in step S1 can be displayed on the display device 54. FIGS. 9, 11, 12, and 14 are examples of the display device 54 having a user interface. The parameters that are in a trade-off relationship in manufacturing the product are displayed in the lower left corner (i.e., second portion) of FIGS. 9, 11, 12, and 14 in the form of triangle, in which the user can modify all three parameters by moving the movable icon. The parameters can also be shown in the lower right corner (i.e., third portion) of FIGS. 9, 11, 12, and 14. In this example, carbon neutrality, cost, and efficiency are shown as parameters, which are examples of trade-off relationships.

In step S3, the trade-off percentages displayed in FIGS. 9, 11, 12, and 14 can be input to the numerical input acceptance field in the input section (i.e., third portion) displayed on the user interface. In addition to the numerical input acceptance field, an input interface such as the one shown in the lower left (i.e., second portion) of FIGS. 9, 11, 12, and 14 may be used for input. This can display a figure (e.g., polygon) with each parameter in the trade-off relationship at a separate point (e.g., the apex or vertex) on the display device 54. In one example in FIGS. 9, 11, 12, and 14, a triangle with carbon neutral, cost, and efficiency at the vertices is shown, but for example, if quality is additionally included in the trade-off relationship, it could be a rectangle with four points (i.e., four vertices). A circle shown inside this figure can identify a movable icon, and the proportions of each parameter can be adjusted to a total of 100 by freely moving the movable icon within the figure by a user input (e.g., using a mouse or other input device 55).

In the example in FIG. 9 the movable icon can initially be located closer to cost, which can make it a cost-oriented trade-off with carbon neutrality at 30, cost at 50, and efficiency at 20. Note that in the example in FIGS. 9, 11, 12, and 14 the tradeoff values can be set for the entire product, but alternatively they can be set for each resource data.

Similarly, when there are four vertices, it may be in the form of a rectangle or a square or any shape, and the user input (i.e., the numerical input acceptance field) on the lower right-hand side of the user interface (i.e., third portion) will also include the four parameters, which the user can individually modify. The parameters may be represented by a percentage or a number, each of which total to 100 (e.g., 100 percent or 100), and these numbers may also represent a priority (e.g., focus). Upon input to one of the parameters, the user interface can automatically total the percentage to 100 by adjusting the other parameters. For example, if the user changes “Carbon Neutral” to 60, the user interface will lower cost and efficiency to allows for a total of all the parameters to equal 100. Since the cost is 50 or 50%, and the efficiency is 20 or 20%, cost is 2.5 times more important (i.e., has 2.5 times greater priority). When carbon neutrality is changed to 60, the user interface can maintain the 2.5 times difference between cost and efficiency, such that cost will be rounded down to 28 (or rounded up to 29) and efficiency will be rounded to up to 12 (or rounded down to 11), to total 40/40%. However, the user interface, upon receiving an input to one parameter, may wait a predetermined period of time or until all the parameters or at least two of the parameters are entered to bring the total number to 100.

In step S4, resource data can be extracted from the resource data storage section 22 based on the input trade-off ratio input in the second portion or the third portion of the user interface. Resource data extraction can be performed based on steps S41 through S43. This is illustrated using the examples in FIGS. 2 and 3.

First, in step S41, resource data necessary for manufacturing the product (e.g., the selected product) can be extracted. Extracted products can be from the product information that match the product ID in the order information. Next, the material, the process, and power consumption information that matches the material ID, process ID, and power ID recorded in the product information can be extracted. This information (e.g., the process, and power consumption information, the material ID, process ID, and power ID recorded) can be used for normal manufacturing of the product.

Next, in step S42, the trade-off values can be reflected (e.g., displayed on the user interface) in the extracted resource data. The method of reflecting the tradeoffs can depend on which parameters are emphasized. For carbon footprint and cost, the method of reflecting the tradeoffs can depend on how much importance (i.e., percentage) is placed on the parameter. If the trade-off value is the largest, the required value can be less than or equal to the resource data associated with the parameter minus a percentage of the trade-off value. If the trade-off value is the second highest, the requested value can be the range of the resource data associated with the parameter plus or minus the percentage of the trade-off value. If the trade-off value is the smallest, the required value can be equal to or greater than the value obtained by adding the percentage of the trade-off value to the resource data related to the parameter.

For efficiency, production can be executed at the ratio of the trade-off value. In other words, efficiency can be based on a percentage of the maximum production capacity per hour. Efficiency can be calculated by multiplying the percentage of the trade-off value by the maximum production capacity. As an example, based on the tradeoffs entered in FIG. 9, the most important parameter can be cost, the second most important can be carbon neutral, and the least important parameter can be efficiency. For example, in the case of material information, price and PCF can reflect the percentage of trade-offs, with −50% for cost and +−30% for PCF. In the example in FIG. 2, numbers/identifiers 0001, 0102, 0203, and 0304 can be extracted as parts information for Product ID 10001. Since the price of material ID 0001 can be 5 from the material information table in FIG. 3, the price 5 can be multiplied by the cost (1-0.5) to obtain 2.5, and PCF: 1.2 can be multiplied by the carbon neutral (1+−0.3) to obtain 0.84 to 1.56. For example, the same calculation can be performed for other components. For process information, the trade-off ratio can be reflected in the maximum production capacity and maximum power used (e.g., power consumption). As mentioned earlier, due to the cost focus, more electricity cannot be used, and production capacity may be required to be reduced.

In this example of FIG. 9, an efficiency of 20% can be multiplied by the maximum production capacity and maximum power used (i.e., power consumption). The process IDs can be 0101, 0102, 0103, and 0200, respectively, and the maximum production capacity reflecting the trade-off can be 0101:24, 0102:40, 0103:50, and 0200:60. Looking at the entire process, the first process can have the lowest production capacity, and only 24 pieces of work-in-progress can be delivered per hour to the subsequent processes, so the maximum number of pieces that can be produced in the entire process can be 24. The maximum power consumption can be 0101:12, 0102:480, 0103:1360, and 0200:48, respectively.

Next, in step S43, the resource data can be extracted again (e.g., re-extracted) subject to the resource data reflecting the trade-off values. For example, the user selected cost can be 2.5 and the user selected PCF can be 0.84 to 1.56. Material ID 0001 may not be applicable, since the cost of 5 is greater than the user selected cost of 2.5, however, the PCF can be within this range. The components with the same function that meet these conditions can be searched for and extracted. In the example shown in FIG. 3, component ID 0002 can be applicable these user selected options.

If there are multiple components (e.g., products), the component with the best value of the data related to the most important trade-off parameter can be extracted. Other components can be extracted in the same way. Next, the power consumption information that matches the trade-off ratio can be extracted. In this example, the power consumption information can be extracted by considering (i.e., factoring in) the percentage of the carbon neutrality parameter in the trade-off relationship with the other parameters. Power consumption can have a different carbon footprint depending on the electricity source. Therefore, the optimal power source can be extracted according to the percentage of carbon neutrality. If the carbon neutrality is less than 40%, 0991 can be extracted; if 40% to 55%, 0992 can be extracted; and if 56% to 69%, 0993 can be extracted (the same applies to 70% and beyond), for example. Since the carbon neutrality can be 30% from the example in FIG. 9, the power consumption information of 0991 (e.g., coal) can be used as in normal manufacturing. The information extracted in steps S41 to S43 can be developed in memory 52 based on the resource data extraction section 31.

In step S5, the PCF and related parameters can be calculated from the information extracted in step S4. The example in FIG. 3 is used to illustrate this step. The PCF of the parts can be the total PCF of the four parts re-extracted in step S43 to create the selected product. From step S42, 24 pieces can be produced per hour, which can mean that the total operating time can be 41.7 hours, for example, as shown in FIG. 10. The total electricity consumption of 79,230 can be calculated from the electricity used and the total operating hours, for example. Multiplying this by the PCF obtained from the electricity information (i.e., electricity consumption and/or electricity/power generation) and allocating it equally among the 1,000 units produced, the PCF for the manufacturing process per unit can be calculated. The sum of the PCF for the parts and the PCF in the manufacturing process per unit can be the PCF per unit of product.

In step S6, the results calculated in step S5 can be displayed on the display device 54. An example screen for display is shown in FIGS. 10 and 13, which illustrates simulation results according to one or more embodiments of the present disclosure. That is, the values for the parameters entered in the user interface of FIGS. 9 and 12 can be used to simulate a manufactured product. FIGS. 10 and 13 show the total energy cost, the total material cost, the manufacturing date, the CO₂ emissions in kg-CO₂, the production in number of products/pieces per house, the total hours worked to complete the order, the total power consumption in Wh, and the power source used according to one or more embodiments of the present disclosure.

Step S7 can determine whether to execute manufacturing based on the information displayed on the example screen in FIG. 10. The user interfaces shown in FIGS. 9, 11, 12, and 14 can be designated as a first user interface, and the user interfaces shown in FIGS. 10 and 13 can be designated as a second user interface. In this case, the PCF can be 39.4 kg-CO2, which does not meet the PCF of 20 kg-CO2 at the time of order receipt displayed in FIGS. 9, 11, 12, and 14. Since this may not be acceptable to the customer, the process can proceed back to step S3 and the trade-off values for the parameters can be re-entered.

FIG. 11 illustrates an example of the screen when the tradeoff values are entered again by returning to step S3 according to one or more embodiments of the present disclosure. In this example, the center circle can be set closer to carbon neutral, and the tradeoff can be set to be carbon neutrality can be set to 55, cost can be set to 10, and efficiency can be set to 35.

If manufacturing is judged to be infeasible in step S7 and the tradeoff values are entered in step S3 for the second and subsequent times, the function to support input can be enabled on the user interface at the second portion and the third portion. This function can allow the operator to select which of the parameters in the tradeoff relationship is more important, thereby narrowing the input range for each parameter. For example, the first trade-off parameter may have been entered with an emphasis on cost. When returning to step S3 to input the second tradeoff value, if the operator wants to set the value with an emphasis on carbon neutrality, the operator can select carbon neutrality from the tradeoff emphasis setting parameter in the lower right portion (i.e., second portion) of FIG. 12. In FIG. 12, the area of the triangle in the lower left corner of FIG. 12 (i.e., second portion) where the carbon neutral tradeoff value is worse than the previous input value can be grayed out, and the center circle is not moved. That is, the grayed out area can represent a previous input value prohibited from being accessed by a user to avoid a worse tradeoff from the previously input value.

Next, in step S4, resource data can be extracted from the newly input trade-off values (see, e.g., step S3). Since the product to be manufactured can remain the same, the resource data for normal manufacturing may have already been extracted in the first step S41 and can already exist in memory 52. Next, in step S42, the trade-off values can be reflected (e.g., displayed on the display device 54) at this time. For example, since the emphasis in FIG. 12 is on carbon neutrality, the cost and PCF can be set to +10% and −55%, respectively, for the part information. For component ID 0001, the price 5 can be multiplied by cost (1+0.1) to get 5.5, and PCF of 1.2 can be multiplied by carbon neutrality (1-0.55) to get 0.54. The calculations for other components can be performed in the same manner.

For process information, the trade-off percentage can be reflected in the maximum production capacity and maximum power used (i.e., power consumption). In this example, an efficiency of 35% can be multiplied by the maximum production capacity and maximum power used (i.e., power consumption). The Process IDs can be 0101, 0102, 0103, and 0200, respectively, and the maximum production capacity reflecting the trade-off can be the following: for Process ID 0101, the maximum production capacity can be 42, for Process ID 0102, the maximum production capacity can be 70 for Process ID 0103, the maximum production capacity can be 87, and for Process ID 0200, the maximum production capacity can be 105. The maximum number of units that can be produced in the entire process may be 42. The maximum power consumption can be 21 for Process ID 101, 840 for Process ID 0102, 2380 for Process ID 0103; and 84 for Process ID 0200, respectively. If the difference in the number of pieces produced between processes is large, the process may be changed so that the work-in-progress from the previous process is stored once on the shelf.

Next, as step S43, the resource data can be extracted again (i.e., re-extracted) subject to the resource data reflecting the trade-off value. For example, the user selected cost can be 4.5 and the user selected PCF can be 0.54. In this case, since carbon neutrality is important, the cost can be greater than or equal to this value, the PCF can be less than or equal to this value, and the component with the same functionality that meets the conditions can be extracted. In the example shown in FIG. 3, component ID 0004 can correspond to these user selected options. Other components can be extracted in the same way. Next, the power information that matches the trade-off ratio can be extracted. In this example, the power information can be extracted by considering the carbon neutrality percentage (i.e., trade-off ratio). From the example in FIG. 11, the carbon neutrality can be 55%, so the power information of 0992 (i.e., liquid natural gas (LNG)) can be used.

In step S5, the PCF and related parameters can be calculated from the information extracted in step S4. The example in FIG. 3 can be used to illustrate this. The PCF of the parts can be the total PCF of the parts re-extracted in step S43. From step S42, 42 pieces can be produced per hour, resulting in a total operating time of 23.8 hours, as shown in FIG. 13, “Simulation Result 2.” Total electricity consumption of 79,135 can be calculated from the electricity used and total operating hours. Multiplying this by the PCF obtained from the electricity information and allocating it equally among the 1,000 units produced, the PCF for the manufacturing process per unit can be calculated. The sum of the PCF for the parts and the PCF in the manufacturing process per unit can be the PCF per unit of product.

FIG. 13 illustrates an example of the user interface displayed in step S6 in the form of a simulation of a product to be produced. In step S7, a decision can be made as to whether to execute manufacturing. In this case, the PCF can be 20.0 kg-CO2, which can meet the PCF: 20 kg-CO2 at the time of order receipt displayed in FIG. 11. If the cost and delivery date are also checked and it is determined that manufacturing is feasible, the process can move to production plan generation (e.g., step S8). At this time, data for the parts extracted in step S43 can be stored in the product parts configuration memory section 24. If data such as profit margins are available, a quotation for the product may be prepared by the quotation generator 40 based on the costs calculated in the flow in FIG. 7.

As step S8, a production plan can be generated based on the calculated PCF value and extracted resource data. In the production plan, for example, the type, quantity, timing, materials, process, and number of days from manufacturing to shipping of the products to be produced can be subject to planning. By step S7, the product type, quantity, timing (e.g., delivery date), materials, and process have been determined. Based on this information, a production plan can be generated. For parts and materials, the necessary parts, and materials when the product is determined to be ready for production in step S7 can be stored in the product parts configuration memory section 24. Manufacturing can be executed using these determined parts and materials. The number of parts and materials in stock can be checked in the resource data storage section 22, and if the necessary materials are not available, a separate order can be placed. The embodiments of the present disclosure can be directed to a manufacturing plan drafting device.

Since the delivery date and time required for manufacturing have been calculated by step S7, the start date can be calculated from this. In the example above, the delivery date can be 2023 Dec. 22 and the total operating hours can be 23.8. If the company can operate all day, it can be possible to manufacture the product by the delivery date if the production is started by December 2020. The start date can vary depending on the current production plan, time required to procure parts, etc. The production plan generation section can refer to the current production plan from the production plan storage section, search the availability of the necessary processes, draw up a schedule that can meet the total operation time and delivery date, and store the schedule in the production plan storage section. If parts and materials need to be procured, a separate system can be used to place orders, and the time required to obtain the parts and materials can be reflected in the production plan. This can be done, for example, by adding a process for obtaining parts and materials before the first process. For electricity, for example, the electricity generated by the relevant power source is purchased from the power company, and the electricity used during production is that electricity. By these means, the production plan can be developed so that the PCF value is the PCF value calculated in step S7.

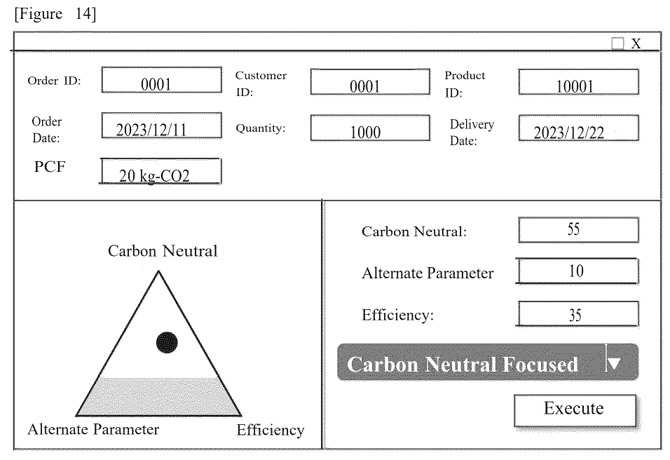

FIG. 14 illustrates a user interface that is a modified version of FIG. 9 according to one or more embodiments of the present disclosure, in which one or more of the parameters (i.e., Carbon Neutral, Cost and Efficiency) can be changed to an “alternate parameter.” The alternate parameter(s) can be product lifetime, quality, safety, ease of disposal, ease of recycling, etc. Although FIG. 14 illustrates the parameter “cost” being changed for “alternate parameter,” any of “Carbon Neutral,” “Cost,” and “Efficiency” can be changed for the alternate parameter. In addition, the user interface can include more than three parameters, including 4 or more parameters, and the input interface including the movable icon can also have any shape with any number of vertices to accommodate any number of parameters.

One or more embodiments of present disclosure can encompass various modifications to each of the examples and embodiments discussed herein. One or more features described above in one embodiment or example can be equally applied to another embodiment or example described above. The features of one or more embodiments or examples described above can be combined into each of the embodiments or examples described above. Any full or partial combination of one or more embodiments or examples can also be implemented.

Various embodiments described herein may be implemented in a computer-readable medium using, for example, software, hardware, or some combination thereof. For example, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software code can be implemented with a software application written in any suitable programming language. Also, the software codes can be stored in the memory and executed by the controller, thus making the controller a type of special purpose controller specifically configured to carry out (i.e., conduct) the described functions and algorithms. Thus, the components shown in the drawings have sufficient structure to implement the appropriate algorithms for performing the described functions.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. This includes the data storage 20, and the components of the data storage 20, including the order information storage 21, the resource data storage 22, the production plan storage 23 and the product parts configuration storage 24. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

1. A product carbon footprint (PCF) calculation device, comprising:
data storage to store order information, resource data, products parts configuration and production plans;
a display; and
circuitry configured to:
receive a user input, the user input including a product to be manufactured and parameters for the product to be manufactured;
extract the resource data from the data storage;
perform PCF calculation based on the extracted resource data and the order information;
display the PCF calculation on the display; and
cause the execution of manufacturing of the product.

2. The PCF calculation device according to claim 1, wherein the display includes a first user interface, and
wherein the first user interface includes:
a first portion including product and customer information; and
a second portion including a polygon with a plurality of vertices, each vertex representing a parameter for selecting the product and a manufacturing process for manufacturing the product, and
wherein each parameter is user modifiable.

3. The PCF calculation device according to claim 2,
wherein the polygon further includes a movable icon, and
wherein the circuitry is configured to modify a priority of the parameters in response to a user moving the movable icon within the polygon.

4. The PCF calculation device according to claim 3,
wherein the first user interface further includes a third portion, the third portion including each of the parameters next to a corresponding percentage,
wherein the third portion is configured to receive the user input of at least one of the percentages for the parameters in the third portion, and
wherein in response to the user moving the movable icon within the polygon, the circuitry is configured to automatically update the percentages displayed in the third portion.

5. The PCF calculation device according to claim 4,
wherein the parameters include carbon neutrality, cost and efficiency, and
wherein the circuitry is further configured to calculate the cost and efficiency to produce the product based on the order information, the resource data and at least one of the inputted percentages of the parameters or the movement of the movable icon.

6. The PCF calculation device according to claim 5,
wherein the first user interface further includes an execution icon, and
wherein upon a user selecting the execution icon, the circuitry is configured to cause an order to be submitted and the product to be manufactured.

7. The PCF calculation device according to claim 5,
wherein the circuitry is further configured to display, after calculating the PCF, a second user interface, and
wherein the second user interface includes cost and manufacturing data of the product.

8. The PCF calculation device according to claim 7,
wherein the cost includes total energy cost and total material cost, and
wherein the manufacturing data includes CO₂ emissions, number of products produced per hour, total power consumption in watt-hours (Wh), and a type of power source used.

9. The PCF calculation device according to claim 1,
wherein the data storage stores the order information in an order information storage section, and
wherein the order information storage section is a table including:
a first column designated as order identification (ID);
a second column designated as customer ID; and
a third column designated as product ID.

10. The PCF calculation device according to claim 9, wherein the order information storage section further includes:
a fourth column designated as order date;
a fifth column designated as quantity;
a sixth column designated as delivery date; and
a seventh column designated as PCF.

11. A method of performing product carbon footprint (PCF) calculation, comprising:
obtaining order information for a product from a first input of a user;
displaying, on a display, the order information and parameters for the order information;
inputting, by the user, percentages for the parameters;
extracting resource data from data storage, the resource data including a time to manufacture the product and power to be consumed in the manufacture of the product;
calculating the PCF based on the percentages for the parameters and the resource data; and
causing an order to be created and the product to be produced.

12. The method according to claim 11, further comprising displaying the calculated PCF in a user interface on the display,
wherein the user interface includes:
a first portion including product and customer information; and
a second portion including a polygon with a plurality of vertices, each vertex representing a parameter for selecting the product and a manufacturing process for manufacturing the product, and
wherein each parameter is user modifiable.

13. The method according to claim 12,
wherein the polygon further includes a movable icon, and
wherein the method further comprises modifying the percentages of the parameters in response to the user moving the movable icon within the polygon.

14. The method according to claim 13,
wherein the user interface further includes a third portion, the third portion including each of the parameters next to a corresponding percentage, and
wherein the method further comprises, in response to the user moving the movable icon within the polygon, automatically updating the percentages displayed in the third portion or receiving an input to at least one of the percentages of the parameters in the third portion.

15. The method according to claim 14,
wherein the parameters include carbon neutrality, cost and efficiency, and
wherein the method further comprises calculating the cost and efficiency to produce the product based on the order information, the resource data and the input to the at least one of the percentages of the parameters.

16. A non-transitory computer-readable storage medium having stored therein computer-readable instructions as part of a processing program to be used in a processing apparatus, the processing program when executed by computer causing the computer to implement a method of performing product carbon footprint (PCF) calculation, comprising:
obtaining order information for a product from a first input of a user;
displaying, on a display, the order information and parameters for the order information;
inputting, by the user, percentages for the parameters;
extracting resource data from data storage, the resource data including a time to manufacture the product and power to be consumed in the manufacture of the product;
calculating the PCF based on the percentages for the parameters and the resource data; and
causing an order to be created and the product to be produced.

17. The non-transitory computer-readable storage medium of claim 16, wherein the method further comprises displaying the calculated PCF in a user interface on the display,
wherein the user interface includes:
a first portion including product and customer information; and
a second portion including a polygon with a plurality of vertices, each vertex representing a parameter for selecting the product and a manufacturing process for manufacturing the product, and
wherein each parameter is user modifiable.

18. The non-transitory computer-readable storage medium of claim 17,
wherein the polygon further includes a movable icon, and
wherein the method further comprises modifying the percentages of the parameters in response to a user moving the movable icon within the polygon.

19. The non-transitory computer-readable storage medium of claim 17,
wherein the user interface further includes a third portion, the third portion including each of the parameters next to a corresponding percentage, and
wherein the method further comprises, in response to the user moving the movable icon within the polygon, automatically updating the percentages displayed in the third portion.

20. The non-transitory computer-readable storage medium of claim 19,
wherein the parameters include carbon neutrality, cost and efficiency, and
wherein the method further comprises calculating the cost and efficiency to produce the product based on the order information, the resource data and the inputted percentages of the parameters.
